(19) United States
(12) Patent Application Publication
(10) Pub. No.: US 2004/0002327 A1
(43) Pub. Date: Jan. 1, 2004

(54) Transmission apparatus, method and computer program product

(75) Inventor: Shingo Tanaka, Yokohama-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/607,235

(22) Filed: Jun. 27, 2003

(30) Foreign Application Priority Data
Jun. 28, 2002 (JP) 2002-191195

(51) Int. Cl. H04M 3/00

(52) U.S. Cl. 455/418; 455/414.1

(57) ABSTRACT

A transmission unit transmits one of data and a command. An input unit inputs one of a first instruction to transmit the data and a second instruction to transmit the command. A first control unit controls the transmission unit to start a first transmission of the data when the input unit inputs the first instruction. A second control unit controls the transmission unit to start a second transmission of the command when the input unit inputs the second instruction and the transmission unit fails to transmit the data. The second control unit also controls the transmission unit to interrupt the first transmission and start the second transmission when the input unit inputs the second instruction and the transmission unit transmits the data.

### CROSS-REFERENCE TO RELATED APPLICATIONS

This application is based upon and claims the benefit of priority from the prior Japanese Patent Application No. 2002-191195, filed Jun. 28, 2002, the entire contents of which are incorporated herein by reference.

### BACKGROUND OF THE INVENTION

1. Field of the Invention

The present invention relates to a transmission apparatus, a method and a computer program product transferring, via a receiving apparatus and communication line, data whose transmission requires a relatively long period of time, and a command that can be instantly transmitted.

2. Description of the Related Art

Recently, data has come to be easily transmitted between various electronic devices, such as digital cameras, personal computers, etc.

Bluetooth (registered trademark) is the name of a radio communication technique generally used for data exchange between small electronic devices. Bluetooth utilizes radio signals of the 2.4 GHz band, and components needed are inexpensive and requires little space. Therefore, it is expected to be widely adapted in portable apparatuses, such as mobile phones, notebook PCs, etc.

In Bluetooth, a number of industry standards, called profiles, are defined, which ensures compatibility between products.

A Profile of Bluetooth include Basic Imaging Profile (hereinafter referred to simply as “BIP”). BIP enables exchange of still image data, control commands, etc. between Bluetooth-installed devices, and is applicable to imaging-specialized devices, such as projectors, digital cameras, etc., as well as information devices, such as PCs, PDAs, mobile phones, etc.

BIP has six features—Image Push feature, Image Pull feature, Remote Display feature, etc.. Briefly speaking, these six features correspond to six specifications/applications into which the functions realized by the profile are classified. For example, Imaging Push feature indicates a function for transmitting an image to a destination, and Image Pull feature indicates a function for acquiring an image from a destination.

For BIP, refer to Bluetooth SIG. homepage (http://www.Bluetooth.org/). For more details of BIP, refer to BIP_{—}0_{—}95c.pdf placed in http://www.Bluetooth.org/docman2/ViewCategory.php?group_ID=53&category_id=214/.

The BIP Remote Display feature will now be described.

The Remote Display feature provides a function for enabling images to be transmitted from one device to another, and enabling the one device to make the other device display a desired one of the transmitted images. In other words, this feature provides an Initiator function (for a device for transmitting image data and an image display command) and Responder function (for a device for receiving image data and an image display command). Further, PutImage function and Remote Display function are provided for image data transfer and image display command transfer, respectively.

This feature is used for, for example, presentation.

This will be described in more detail. For example, image data (e.g. JPEG image data) from each slide to be displayed on a projector during presentation is pre-stored in the storage of a PDA. The PDA is connected to the projector in a presentation hall, and the image data of each slide is transmitted from the PDA to the projector. Presentation is performed by sequentially transmitting the images on desired slides from the PDA to the projector and sequentially displaying them on the projector. Thus, presentations can be made merely using a PDA to a presentation hall. Further, a PDA can be used as a remote controller during a presentation.

The Remote Display feature can also be utilized to send image data from a digital camera to a connected TV set, for display purposes. Thus, images can be easily and directly displayed on a TV set without downloading to a PC.

However, since the Remote Display feature of BIP only uses a single logic connection, it is impossible to simultaneously transmit image data and an image display command from an Initiator to a Responder. Accordingly, in the prior art, to transmit a plurality of image data items and an image display command, one of the following one of an action (1) and an action (2) must be performed. (1) After all image data items to be displayed have been transmitted, an image display command corresponding to desired image data is transmitted. (2) During transmission of image data, an image display command is inserted, i.e., an image display command is transmitted after the completion of currently-transmitted image data, and before the transmission of the next image data.

An image display command is issued by a user input operation. It is important that the user's input, to an Initiator device, of a command to display a desired image be synchronous with the display of the desired image on a Responder device.

For example, when a user has input, to a PDA, a command to display the image data of the next page (slide) on a projector, the projector must display the image data promptly, otherwise, the operability and performance are significantly degraded.

In the above-described example, however, when normal presentation slides are used, about 10 seconds are required to transmit one slide, according to the amount of image data, even if it is in JPEG format of a high compression ratio. Therefore, in (1), in which all image data is transmitted beforehand, a user must wait a long time before an initial image is displayed. On the other hand, in (2), in which an image display command is transmitted after currently-transmitted image data has been completely transmitted, realtime image display cannot be realized.

### BRIEF SUMMARY OF THE INVENTION

The present invention has been developed in light of the above, and aims to provide a transmission apparatus, a method and a computer program product for starting display of image data without keeping a user waited a long time, while transmitting a number of image data items, and also capable of realizing realtime image display.

To satisfy the aim, according to a first aspect of the invention, there is provided a transmission apparatus comprising: a transmission unit configured to transmit one of data and a command; an input unit configured to input one of a first instruction to transmit the data and a second instruction to transmit the command; a first control unit configured to control the transmission unit to start a first transmission of the data when the input unit inputs the first instruction; and a second control unit configured to control the transmission unit to start a second transmission of the command when the input unit inputs the second instruction and the transmission unit fails to transmit the data, the second control unit also controlling the transmission unit to interrupt the first transmission and start the second transmission when the input unit inputs the second instruction and the transmission unit transmits the data.

According to a second aspect of the invention, there is provided a transmission method comprising: transmitting one of data and a command; inputting one of a first instruction to transmit the data and a second instruction to transmit the command; starting a first transmission of the data when the first instruction is input; starting a second transmission of the command when the second instruction is input and the data fails to be transmitted; and interrupting the first transmission and starting the second transmission when the second instruction is input and the data is transmitted.

According to a third aspect of the invention, there is provided a computer program product configured to store program instructions for execution on a computer system enabling the computer system to perform: transmitting one of data and a command; inputting one of a first instruction to transmit the data and a second instruction to transmit the command; starting a first transmission of the data when the first instruction is input; starting a second transmission of the command when the second instruction is input and the data fails to be transmitted; and interrupting the first transmission and starting the second transmission when the second instruction is input and the data is transmitted.

### BRIEF DESCRIPTION OF THE SEVERAL VIEWS OF THE DRAWING

FIG. 1 is a block diagram illustrating an example of an internal configuration of a command transmission apparatus according to a first embodiment of the invention, and an example of a data transmission system configuration including the command transmission apparatus;

FIG. 2 is a flowchart illustrating an example of an operation of the data transmission system according to the first embodiment;

FIG. 3 is a view useful in explaining an operation of the first embodiment;

FIG. 4 is a view useful in explaining an operation of the first embodiment;

FIG. 5 is a view useful in explaining an operation of the first embodiment;

FIG. 6 is a flowchart illustrating another example of the operation of the data transmission system according to the first embodiment;

FIG. 7 is a block diagram illustrating an example of an internal configuration of a command transmission apparatus according to a second embodiment of the invention, and an example of a data transmission system configuration including the command transmission apparatus;

FIG. 8 is a flowchart illustrating an example of an operation of the data transmission system according to the second embodiment;

FIG. 9 is a view useful in explaining an operation of the second embodiment;

FIG. 10 is a view useful in explaining an operation of the second embodiment;

FIG. 11 is a view useful in explaining an operation of the second embodiment; and

FIG. 12 is a flowchart illustrating another example of the operation of the data transmission system according to the second embodiment.

### DETAILED DESCRIPTION OF THE INVENTION

Embodiments of the invention will be described with reference to the accompanying drawings.

(First Embodiment)

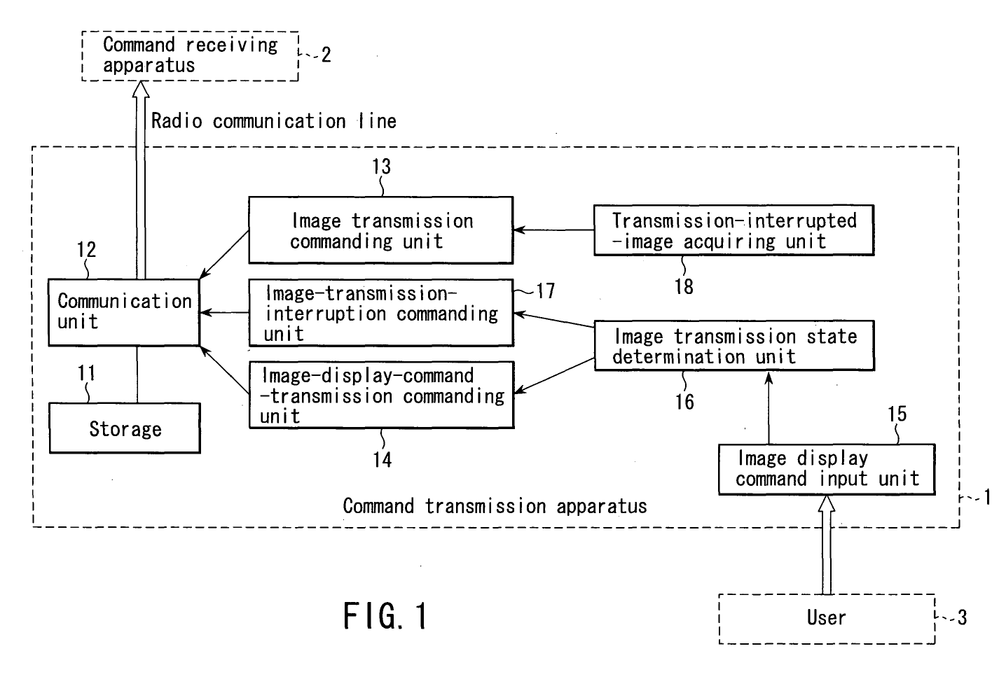

FIG. 1 shows an example of an internal configuration of a command transmission apparatus 1 according to a first embodiment of the invention, and an example of a data transmission system configuration including the command transmission apparatus.

As shown in FIG. 1, the data transmission system comprises a command transmission apparatus 1 for transmitting image data and an image display command in accordance with an operation by a user 3, and a command receiving apparatus 2 for receiving the image data and the image display command from the command transmission apparatus 1, and displaying the received image data on the basis of the received image display command. The command transmission apparatus 1 and the command receiving apparatus 2 are connectable via a communication line.

In the embodiment, assume that the command transmission apparatus 1 cannot simultaneously transmit image data and an image display command to the command receiving apparatus 2. Also assume that the communication line connects the apparatuses 1 and 2 using a single logical connection, therefore cannot simultaneously pass image data and an image display command.

The communication line may be wired or wireless.

To use radio communication standard Bluetooth for a communication line, the command transmission apparatus 1 needs to have an Initiator function of the Bluetooth BIP Remote Display feature, while the command receiving apparatus 2 needs to have a Responder function of the BIP Remote Display feature. Further, the BIP PutImage function is used to transfer image data from the command transmission apparatus 1 to the command receiving apparatus 2, while BIP Remote Display function is used to transfer an image display command from the apparatus 1 to the apparatus 2. Furthermore, for interruption of image data transfer, which will be described later, Abort operation of Generic Object Exchange Profile as a low-order layer of BIP can be utilized.

As shown in FIG. 1, the command transmission apparatus 1 of the embodiment comprises: a storage 11 for storing image data; a communication unit 12 for communication with the command receiving apparatus 2; an image transmission commanding unit 13 for supplying the communication unit 12 with a command to transmit particular image data stored in the storage 11; an image-display-command-transmission commanding unit 14 for supplying the communication unit 12 with a command to transmit a command for causing the command receiving apparatus 2 to display image data; an image display command input unit 15 operable parallel to the communication unit 12 and receiving an instruction, issued by a user, to output an image display command; an image transmission state determination unit 16 operable parallel to the communication unit 12 and determining whether or not the communication unit 12 is now transmitting image data; an image-transmission-interruption commanding unit 17 operable parallel to the communication unit 12 and supplying the unit 12 with a command to interrupt image data transmission; and a transmission-interrupted-image acquiring unit 18 for acquiring information concerning transmission of which image data has been interrupted by the image-transmission-interruption commanding unit 17.

In the embodiment, the command transmission apparatus 1 may be a digital camera, and the command receiving apparatus 2 be a TV set. In this case, for example, the digital camera transfers, to the TV set, image data stored therein and an image display command, with the result that the image data is displayed on the screen of the TV set to enable a user to see it.

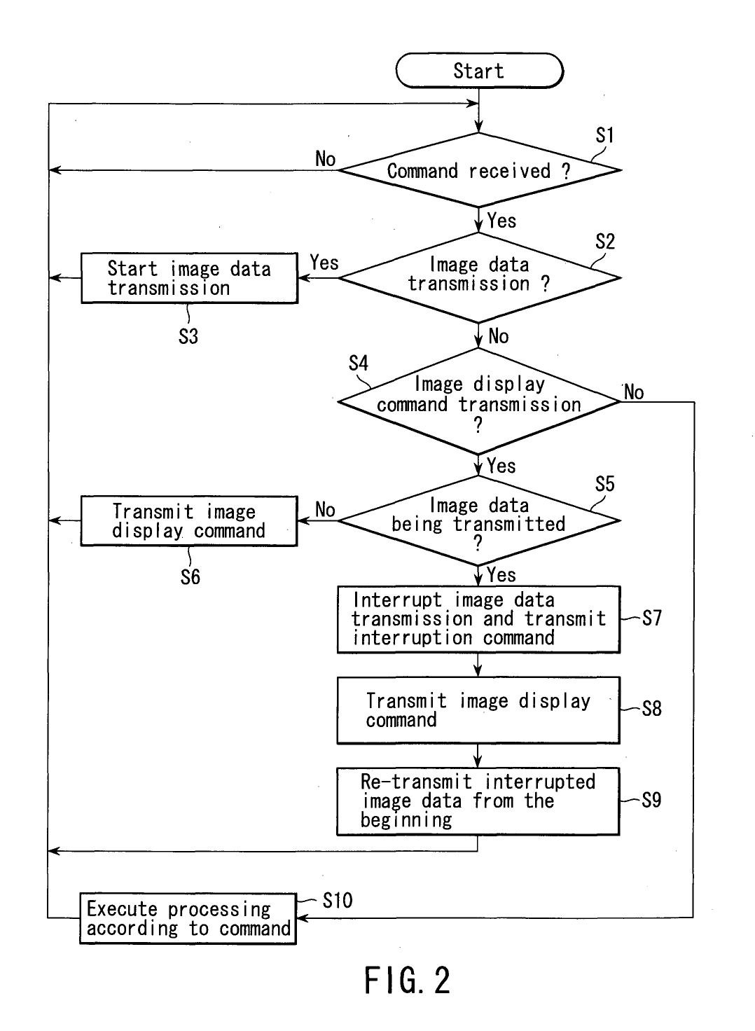

FIG. 2 shows an example of an operation of the data transmission system according to the first embodiment.

Assume that each image data item can be specified at least between the command transmission and receiving apparatuses 1 and 2. For example, assume that image data transferred from the command transmission apparatus 1 to the command receiving apparatus 2 is provided with identification information for identifying the image data at least between the apparatuses 1 and 2. This identification information may be, for example, information indicative of the order in which present image data is actually transferred between the apparatus 1 and the apparatus 2, a data name or file name assigned to image data, etc..

Further, image data and an image display command may be discriminated from each other by information assigned to the header of data and indicative of whether the data is image data or an image display command, or by another method.

When a user has issued an instruction (step S1), if the instruction instructs transmission of certain image data (step S2), transmission of the image data designated by the user to the command receiving apparatus 2 is started (step S3). This transmission is interrupted if an image display command is generated.

If the instruction from the user indicates transmission of an image display command for certain image data (step S4), it is firstly determined whether or not image data is now being transmitted from the command transmission apparatus 1 to the command receiving apparatus 2. If no image data is transmitted (step S5), the image display command corresponding to the image data designated by the user is transmitted to the command receiving apparatus 2 (step S6).

On the other hand, if image data is transmitted from the command transmission apparatus 1 to the command receiving apparatus 2 (step S5), the current image data transmission is interrupted, and an interruption command is sent to the command receiving apparatus 2 (step S7). Then, an image display command corresponding to image data designated by the user is transmitted to the command receiving apparatus (step S8). Thereafter, the interrupted image data transmission is resumed from the beginning (step S9). If another image display command is generated during resumption of transmission, the resumed transmission is again interrupted and re-executed after the transmission of the image display command is completed.

If the received command is another type of command (step S4), processing corresponding to this command is executed (step S10).

In the command transmission apparatus 1, if there is a user's instruction to transmit image data that does not exist, or to transmit an image display command corresponding to image data whose transmission to the command receiving apparatus 2 is not yet completed, it is preferable that processing be executed so as not to accept these instructions.

Furthermore, in the command transmission apparatus 1, if there is a user's instruction to transmit, to the command receiving apparatus 2, image data that has already been transmitted thereto, this instruction may be accepted to again transmit the image data, or may not be accepted, or a message that transmission of the image data is finished is sent to the user, thereby enabling the user to select whether or not the image data should be again transmitted.

On the other hand, if the command receiving apparatus 2 receives image data from the command transmission apparatus 1, it stores the image data together with identification information for the data. If the apparatus 2 receives an image display command corresponding to certain image data from the apparatus 1, it displays the image data corresponding to the command. Further, if the apparatus 2 receives an interruption command from the apparatus 1, it destroys image data received so far.

The first embodiment will now be described specifically.

In this embodiment, assume that the command transmission apparatus 1 is a digital camera, and the command receiving apparatus 2 is a TV set. Further, assume that this digital camera stores, for example, fifty image data items obtained by photography (which will hereinafter be referred to as image data D1-D50), and transmits, to the TV set, image data items designated by a user, and also transmits, to the TV set, an image display command corresponding to the image data item designated by the user, thereby displaying it on the TV set.

Firstly, assume that twenty image data items included in the image data stored in the digital camera as the command transmission apparatus 1 have already been transmitted to the TV set as the command receiving apparatus 2, the twenty items being provided with identification information items D1-D9 and D30-D40. In this case, the TV set can display any one of these twenty image data items upon receiving an image display command corresponding thereto. Thus, the user can display and see an arbitrary one of them.

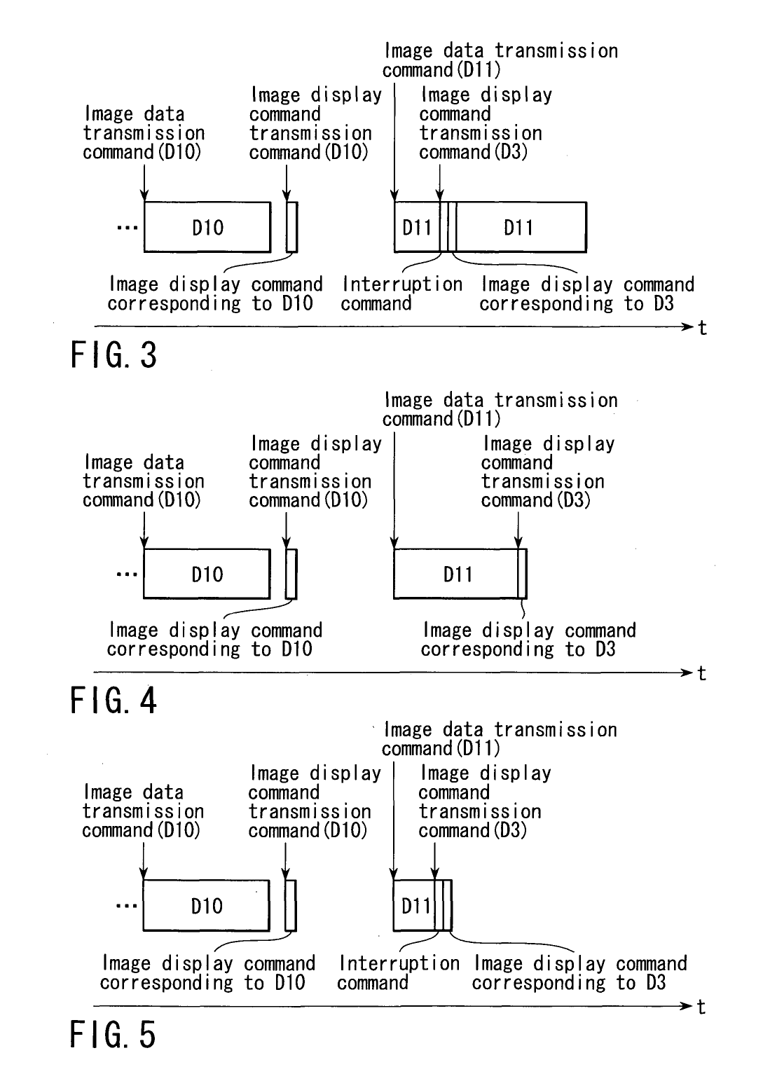

In this state, assume that the user would like to display image data with identification information D10 stored in the digital camera. At this time, if the user issues an instruction to transmit the image data D10 to the TV set, the image data D10 is transmitted from the digital camera to the TV set. Subsequently, if the user issues an instruction to transmit an image display command corresponding to the image data D10, the image display command is transmitted from the digital camera to the TV set, thereby displaying the image data D10 on the TV set. (See FIG. 3)

In this state, assume that the user would like to display image data with identification information D11 stored in the digital camera. At this time, if the user issues an instruction to transmit the image data D11 to the TV set, transmission of the image data D11 from the digital camera to the TV set is started, as is shown in FIG. 3. During the transmission of the image data D11, assume that the user has changed their mind and would like to display image data D3, thereby inputting an image display command corresponding to the image data D3 to the digital camera, as is shown in FIG. 3.

The processing performed from now on will be described in detail with reference to FIG. 3.

Firstly, when the image display command input unit 15 of the command transmission apparatus (digital camera) 1 has received an image display command input by the user, the image transmission state determination unit 16 determined whether or not image data is currently being transmitted. In this case, since the image data D11 is currently being transmitted, it is determined that image data is transmitted.

As a result, the image-transmission-interruption commanding unit 17 supplies the communication unit 12 with a command to interrupt the current image data transmission. The communication unit 12 in turn interrupts the current image data transmission, and transmits an interruption command to the TV set as the command receiving apparatus 2.

After that, the image-display-command-transmission commanding unit 14 supplies the communication unit 12 with an image display command to display the image data D3 that the user would like to display now. Upon receiving this command, the communication unit 12 transmits an image display command corresponding to the image data D3 to the TV set as the command receiving apparatus 2. Upon receiving the command, the TV set displays the image data D3.

After the transmission of the image display command finishes, the transmission-interrupted-image acquiring unit 18 acquires information indicating that the transmission-interrupted image data is the image data D11, thereby informing the image transmission commanding unit 13 of this. The image transmission commanding unit 13 in turn supplies the communication unit 12 with a command to again transfer the image data D11. The communication unit 12 resumes the transfer of the eleventh image data item D11.

As a result of these processes, even during transmission of image data, the command transmission apparatus 1 can transmit an image display command to the command receiving apparatus 2 immediately after the image display command is input by the user. Further, the image data transmission is only suspended and not stopped.

The image transmission state determination unit 16 may use any method to determine the transmission state of image data. For example, the image transmission state determination unit 16 may manage information on the transmission states of data items and use it when determination is needed, or may refer to the communication unit 12 concerning the transmission state of each data item.

Moreover, the transmission-interrupted-image acquiring unit 18 may use any method to acquire information concerning transmission-interrupted image data. For example, the transmission-interrupted-image acquiring unit 18 may inquire it of the communication unit 12. Alternatively, the transmission-interrupted-image acquiring unit 18 may store the identification information of transmission-interrupted image data, and refer to it. The unit 18 may use, as that information, the identification information of image data to be transmitted from the image transmission commanding unit 13. Further, the unit 18 may operate for acquiring the information during or after transmission of an interruption command.

In the procedure example shown in FIG. 2, when an instruction to transmit an image display command has been issued by a user during the transmission of image data, the image data transmission is always and promptly interrupted. However, since there may be a case where current image data transmission finishes soon, whether or not the current transmission should be interrupted may be determined according to the time when a user's instruction to transmit an image display command is received.

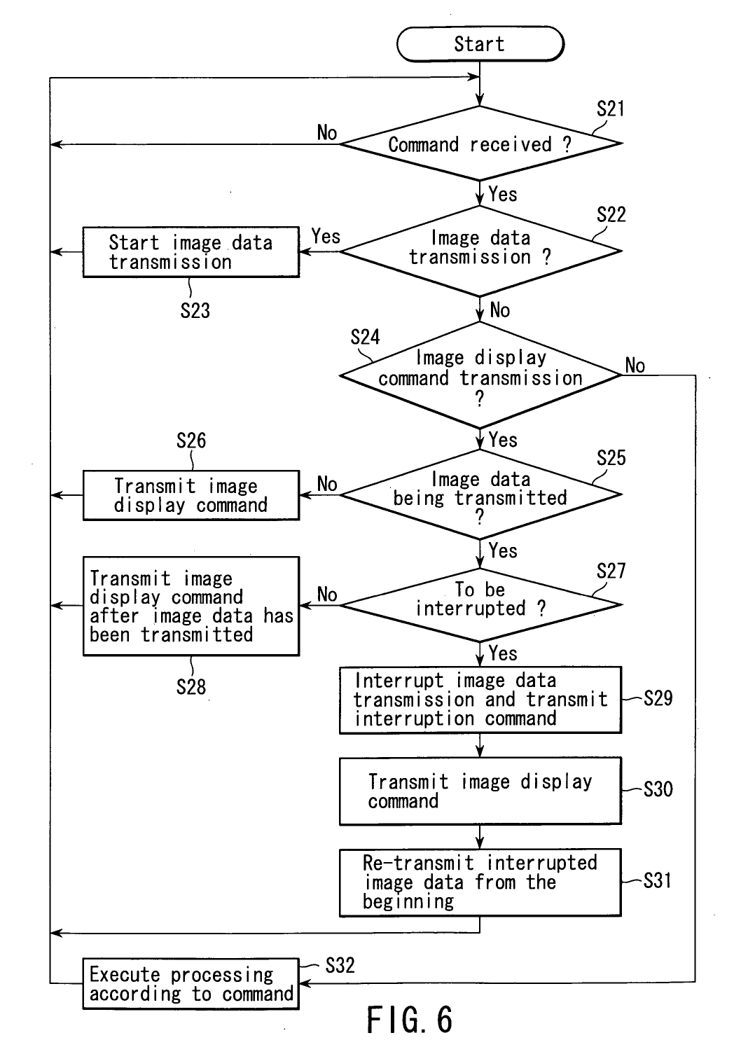

FIG. 6 shows an example of a procedure in this case. This procedure differs from that shown in FIG. 2 in that in FIG. 6, if it is determined that image data transmission should not be interrupted (step S27), an image display command is transmitted after the completion of the image data transmission (step S28), as shown in FIG. 4.

Determination as to whether or not image data transmission should be interrupted can be made using various methods.

For example, (1) if the ratio n/N (N represents the amount of to-be-transmitted image data, and n represents the amount of data having been transmitted) assumed upon reception of an instruction, from a user, to transmit an image display command is less than a threshold value, transmission of image data is determined to be interrupted. On the other hand, if the ratio n/N is not less than the threshold value, image data transmission is determined not to be interrupted.

Further, for example, (2) if an estimated time T required until transmission of to-be-transmitted image data is completed is not less than a threshold value, image data transmission is determined to be interrupted. On the other hand, if the estimated time T is less than the threshold value, image data transmission is determined not to be interrupted. Any known method may be employed to estimate the time required until transmission of to-be-transmitted image data is completed.

In the procedure of FIGS. 2 or 6, if an image display command is generated during image data transmission, thereby interrupting the image data transmission, the transmission-interrupted image data may not be re-transmitted, as is shown in FIG. 5. Furthermore, the determination as to whether or not the transmission-interrupted image data should be re-transmitted may be arbitrarily set by a user.

(Second Embodiment)

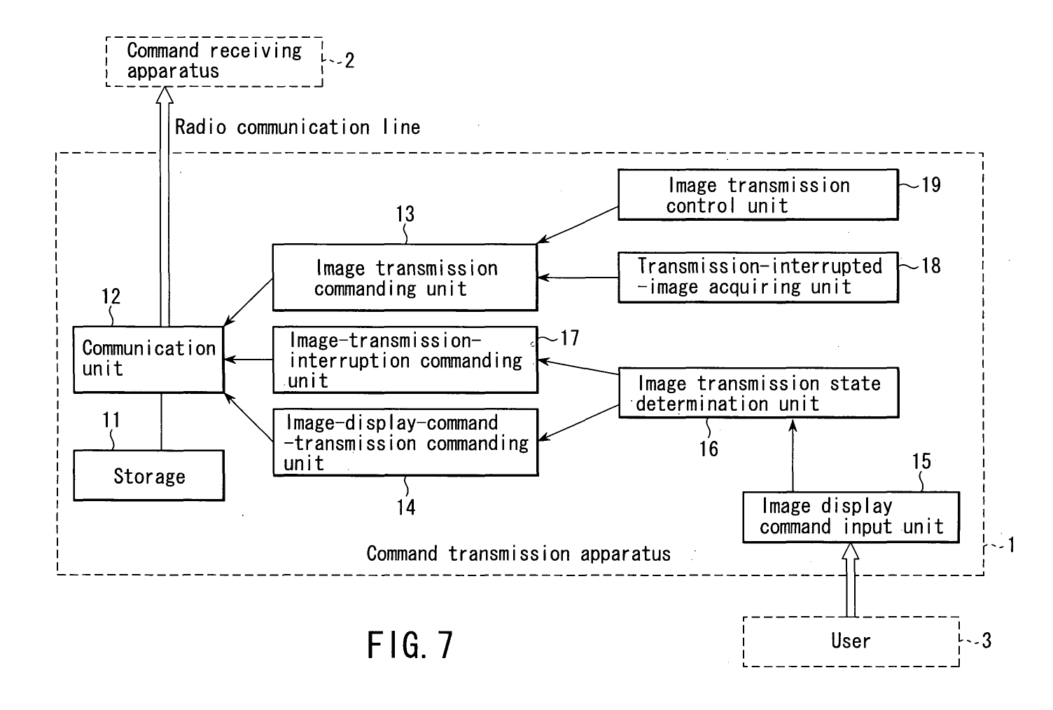

FIG. 7 shows an example of an internal configuration of a command transmission apparatus according to a second embodiment of the invention, and an example of a data transmission system configuration including the command transmission apparatus.

The command transmission apparatus 1 of FIG. 7 is obtained by adding an image transmission control unit 19 to the command transmission apparatus 1 of FIG. 1. The image transmission control unit 19 executes control for sequentially transmitting to-be-transmitted image data items one by one. This enables the command transmission apparatus 1 to transmit image data items to the command receiving apparatus 2 in an order.

In the second embodiment, assume that the communication line connects the apparatuses 1 and 2 using a single logical connection, therefore cannot simultaneously pass image data and an image display command, as in the first embodiment.

Also in the second embodiment, to use radio communication standard Bluetooth for a communication line, the command transmission apparatus 1 needs to have an Initiator function of the Bluetooth BIP Remote Display feature, while the command receiving apparatus 2 needs to have a Responder function of the BIP Remote Display feature. Further, the BIP PutImage function is used to transfer image data from the command transmission apparatus 1 to the command receiving apparatus 2, while BIP Remote Display function is used to transfer an image display command from the apparatus 1 to the apparatus 2. Furthermore, for interruption of image data transfer, which will be described later, Abort operation of Generic Object Exchange Profile as a low-order layer of BIP can be utilized.

A description will now be mainly given of the portion of the second embodiment that differs from the first embodiment.

In the second embodiment, the command transmission apparatus 1 is, for example, a PDA, while the command receiving apparatus 2 is, for example, a projector. In this case, for example, the PDA transfers image data stored therein to the projector in units of slides, and transmits an image display command to the projector, thereby displaying a projection image on, for example, a screen. Thus, image data is used for user's presentation or audience inspection.

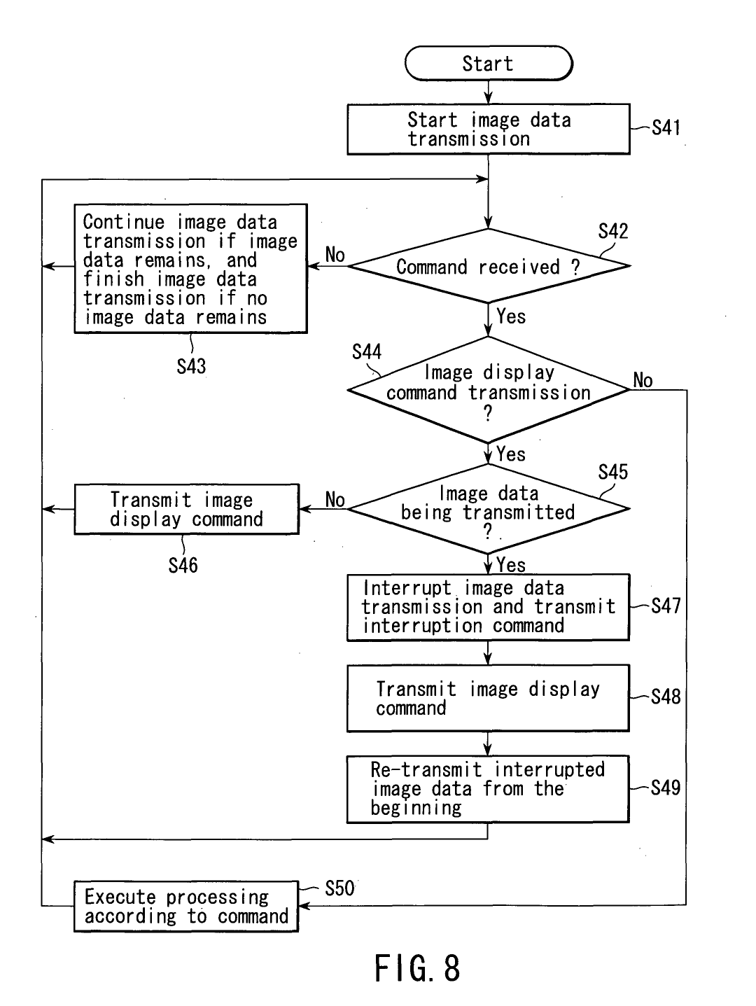

FIG. 8 shows an example of an operation of the command transmission apparatus 1.

Firstly, when, for example, a user has issued a command to transmit all image data items corresponding to all slides, transmission of image data is started (step S41). At this time, the command transmission apparatus 1 transmits image data to the command receiving apparatus 2 in an order as mentioned above.

After that, the command transmission apparatus 1 becomes ready to reception of another instruction from the user.

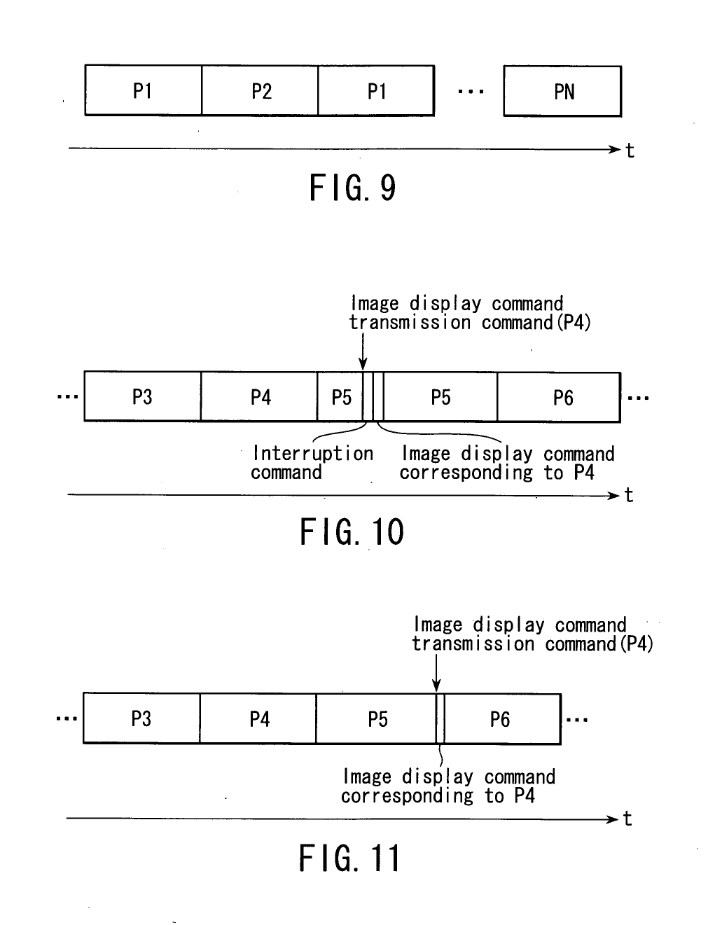

If an instruction to transmit an image display command is not issued by the user (step S42), image data items P1-PN are continuously transferred as shown in FIG. 9 (step S43).

If, on the other hand, there is an instruction from the user (step S42), and if this instruction instructs the command transmission apparatus 1 to transmit an image display command corresponding certain image data (step S44), it is determined, firstly, whether or not image data transmission is now being performed from the command transmission apparatus 1 to the command receiving apparatus 2. If there is no current transmission (step S45), the image display command corresponding to the certain image data, designated by the user, is transmitted to the command receiving apparatus 2 (step S46).

On the other hand, if image data is transmitted from the command transmission apparatus 1 to the command receiving apparatus 2 (step S45), the current image data transmission is interrupted, and an interruption command is sent to the command receiving apparatus 2 (step S47). Then, the image display command corresponding to the image data designated by the user is transmitted to the command receiving apparatus 2 (step S48). Thereafter, the interrupted image data transmission is resumed from the beginning (step S49). If to-be-transmitted image data remains, image data transmission is continued.

When the command receiving apparatus 2 has received image data from the command transmission apparatus 2 as in the first embodiment, it stores the image data together with its identification information. When the apparatus 2 has received an image display command corresponding to certain image data from the apparatus 1, it displays the certain image data. Further, when the apparatus 2 has received an interruption command from the apparatus 1, it deletes image data received so far.

The second embodiment will be described specifically.

In this embodiment, as mentioned above, the command transmission apparatus 1 is a PDA, while the command receiving apparatus 2 is a projector. Assume a case where the PDA holds, for example, ten image data items (JPEG image data items) P1-P10 corresponding to ten slides for presentation, sequentially transmits the image data items P1-P10 to the projector, and transmits, to the projector, an image display command corresponding to a desired one of the already transmitted image data items, when requested by a user, thereby displaying a corresponding projection image on a projector screen. Thus, image data is automatically transmitted under the control of the image transmission control unit 19, while an image display command is transmitted in accordance with the operation by a user.

Referring now to FIG. 10, the above processing will be described in detail.

Firstly, in the PDA as the command transmission apparatus 1, the image transmission control unit 19 causes the image transmission commanding unit 13 to supply the communication unit 12 with a command to transmit the first image data item P1 of the ten slide image data items stored in the storage 11. The communication unit 12, in turn, starts to transmit the first image data item P1 to the projector as the command receiving apparatus 2. At this stage, there is no image data whose transmission is completed, therefore there is no image to be displayed by the projector. Accordingly, the user cannot input an image display command.

Immediately after the transmission of the first image data item P1 is completed, the image transmission control unit 19 causes the image transmission commanding unit 13 to supply the communication unit 12 with a command to transmit the second image data item P2. The communication unit 12, in turn, starts to transmit the second image data item P2. At this stage, the command receiving apparatus 2 holds the first image data item P1, therefore the user can cause the command receiving apparatus 2 to display the first image data item P1.

After that, similar processing is repeated. After the transmission of, for example, the fourth image data item P4 corresponding to a fourth slide is completed, the image transmission control unit 19 causes the image transmission commanding unit 13 to supply the communication unit 12 with a command to transmit the fifth image data item P5. The communication unit 12, in turn, starts to transmit the fifth image data item P5. At this stage, the command receiving apparatus 2 holds the first to fourth image data items, therefore the user can cause the command receiving apparatus 2 to display any one of the first to fourth image data items P1-P4.

During transmission of the fifth image data item P5, if the image display command input unit 15 has input an image display command corresponding to one of the first to fourth image data items P1-P4 (for example, the fourth image data item P4), as shown in FIG. 10, then the image transmission state determination unit 16 determines whether or not image data is currently being transmitted. In this case, since the fifth image data item P5 is transmitted, it is determined that image data is currently transmitted. As a result, the image-transmission-interruption commanding unit 17 supplies the communication unit 12 with an interruption command to interrupt the currently transmitted image data. The communication unit 12, in turn, interrupts the image transmission processing.

After that, the image-display-command-transmission commanding unit 14 supplies the communication unit 12 with an image display command to display the fourth image data item P4. The communication unit 12, in turn, transmits the image display command to the projector as the command receiving apparatus 2. Upon receiving this command, the projector displays the fourth image data item P4 on the screen.

After the processing corresponding to the image display command is completed, the transmission-interrupted-image acquiring unit 18 acquires information indicating that the transmission-interrupted image data is the fifth image data item PS. Then, the image transmission commanding unit 13 commands the communication unit 12 to transmit the fifth image data item P5. The communication unit 12, in turn, resumes the transmission of the fifth image data item P5.

As a result of these processes, even during the transmission of image data, the command transmission apparatus 1 can transmit an image display command to the command receiving apparatus 2 almost in synchronism with the input of the image display command by a user, thereby enabling realtime display of a corresponding image. Further, the transmission of image data is only suspended and not stopped.

As described above, the image transmission control unit 19 causes the image transmission commanding unit 13 to output an image transmission command to transmit the sixth image data item P6 immediately after the fifth image data item P5 has been transmitted. Similarly, the unit 19 causes the unit 13 to output an image transmission command to transmit the seventh image data item P7 immediately after the sixth image data item P6 has been transmitted. As a result, the communication unit 12 is controlled via the image transmission commanding unit 13 so as to automatically and sequentially transmit all image data items corresponding to ten slides. This control is performed regardless of whether or not the previously mentioned processing relating to the transmission of an image display command is performed, therefore sequential transmission of image data items by the image transmission control unit 19 is not interrupted even while the processing relating to the transmission of an image display command is performed.

Further, the user can display already transmitted image data using the projector. This means that immediately after the n-th image data item corresponding to the n-th slide has been transmitted, an image display command corresponding to this image item can be input to display the image. Similarly, immediately after the (n+1)-th image data item corresponding to the (n+1)-th slide has been transmitted, an image display command corresponding to this image item can be input to display the image. It is a matter of course that when the (n+1) image data items can be displayed, an image display command corresponding to an arbitrary one of the first to n-th image data items can be output to display the corresponding image data item.

The advantage resulting from the actual use of the system of the embodiment for presentation will be roughly described.

When an image data item corresponding to the first slide has been transmitted, a user can display the image item and start presentation using the display.

Further, while the user introduces themselves or explains the outline of presentation, using the first slide displayed, image data corresponding to subsequent slides is automatically transmitted. Accordingly, when the user would like to display image data corresponding to the second slide, they can do so by performing the previously described processing, since image data corresponding to, for example, the first to second or third slides have already been transmitted.

Similarly, while the second slide is displayed and explained, sufficient image data corresponding to, for example, the first to fifth or sixth slides have already been transmitted, therefore the third slide can be displayed immediately when the user would like to do so.

As described above, in, for example, a usual presentation where image data items are displayed one by one at a speed lower than that of transmission thereof, image display can be started when image data corresponding to the first slide has been transmitted. Therefore, the user does not have to wait for the start of image display for a long time, and can execute any image display command in a realtime manner. Thus, the user does not almost have to consider the transmission of image data.

After all image data corresponding to the first to tenth slides haven been transmitted, if the image display command input unit 15 inputs an image display command issued by the user, the image transmission state determination unit 16 determined that there is no current transmission of image data. As a result, the image-display-command-transmission commanding unit 14 supplies the communication unit 12 with a command to transmit an image display command.

In the procedure example of FIG. 8, if a user issues, during transmission of image data, an instruction to transmit an image display command, the image data transmission is always interrupted. However, whether or not current transmission should be interrupted may be determined according to the time when a user's instruction to transmit an image display command is received, as in the first embodiment. This determination may be accomplished using the method as described in the first embodiment.

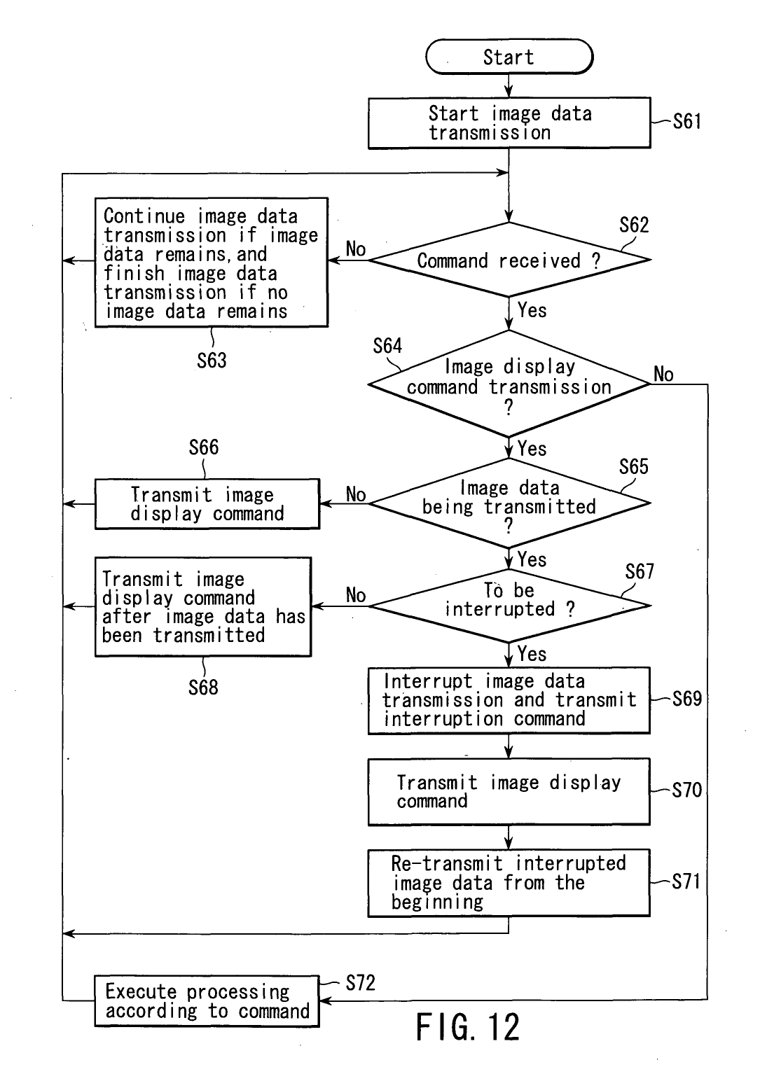

FIG. 12 shows an example of a procedure in this case. This procedure differs from that shown in FIG. 8 in that in FIG. 12, if it is determined that image data transmission should not be interrupted (step S67), an image display command is transmitted after the completion of the image data transmission (step S68), as shown in FIG. 11.

In the first and second embodiments, the command transmission apparatus 1 explicitly transmits an interruption command to the command receiving apparatus 2 to interrupt image data transmission. Alternatively, the command receiving apparatus 2 can be modified so that it detects interruption of image data transmission without receiving an explicit interruption command.

Further, in the above description, transmission of image data is interrupted, then an image display command is transmitted, and transmission of this image data is resumed from the beginning. Alternatively, only the part of transmission-interrupted image data that is not yet transmitted may be transmitted after interruption.

Furthermore, the first embodiment and the second embodiment may be combined. For example, the command transmission apparatus 1 and the command receiving apparatus 2 may each have a combination of the corresponding functions employed in the first embodiment and the second embodiment.

Each of the above-described functions can be described as software and realized by a computer that can execute the software.

In addition, each of the above-described embodiments can be realized as a program that enables a computer to execute means, to function as means, or to realize a function. Also, it can be realized as a computer-readable recording medium that stores the program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A transmission apparatus comprising:
a transmission unit configured to transmit one of data and a command;
an input unit configured to input one of a first instruction to transmit the data and a second instruction to transmit the command;
a first control unit configured to control the transmission unit to start a first transmission of the data when the input unit inputs the first instruction; and
a second control unit configured to control the transmission unit to start a second transmission of the command when the input unit inputs the second instruction and the transmission unit fails to transmit the data, the second control unit also controlling the transmission unit to interrupt the first transmission and start the second transmission when the input unit inputs the second instruction and the transmission unit transmits the data.

2. The transmission apparatus according to claim 1, further comprising a third control unit configured to control the transmission unit to resume the first transmission interrupted by the second control unit, the first transmission interrupted being restarted after the command has been transmitted.

3. The transmission apparatus according to claim 1, further comprising a third control unit configured to control the transmission unit to sequentially transmit a plurality of data items of the data.

4. The transmission apparatus according to claim 1, wherein when the input unit inputs the second instruction and the transmission unit transmits the data, the second control unit determines whether or not the first transmission should be interrupted,
the second control unit controlling the transmission unit to start the second transmission after the first transmission is completed if the second control unit determines that the first transmission should be uninterrupted,
the second control unit controlling the transmission unit to interrupt the first transmission and start the second transmission if the second control unit determines that the first transmission should be interrupted.

5. The transmission apparatus according to claim 4, wherein when the input unit inputs the second instruction and the transmission unit transmits the data, the second control unit determines whether or not the first transmission should be interrupted,
the second control unit determining that the first transmission should be interrupted if a value obtained by dividing an amount of transmitted part of the data by an entire amount of the data is less than a threshold value,
the second control unit also determining that the first transmission should be uninterrupted if the value obtained is not less than the threshold value.

6. The transmission apparatus according to claim 4, wherein when the input unit inputs the second instruction and the transmission unit transmits the data, the second control unit determines whether or not the first transmission should be interrupted,
the second control unit determining that the first transmission should be interrupted if an estimated period of time for completing the first transmission is not less than a threshold value,
the second control unit also determining that the first transmission should be uninterrupted if the estimated period is less than the threshold value.

7. The transmission apparatus according to claim 1, wherein the transmission unit utilizes a radio communication technique called Bluetooth (registered trademark).

8. The transmission apparatus according to claim 1, wherein the data is image data.

9. The transmission apparatus according to claim 8, wherein the input unit inputs designation of to-be-transmitted image data of the image data.

10. The transmission apparatus according to claim 8 and associated with a receiving apparatus, wherein the command includes an image display command used to command the receiving apparatus to display an image of first image data included in the image data already transmitted to the receiving apparatus.

11. The transmission apparatus according to claim 10, wherein the input unit designates the first image data to display the image by the image display command when inputting an instruction to transmit the image display command.

12. The transmission apparatus according to claim 10, further comprising a transfer unit configured to transfer the image data based on an Initiator function of Remote Display feature incorporated in Basic Imaging Profile of Bluetooth (registered trademark),
transmission of the image data, transmission of the image display command and interruption of the transmission of the image data being performed, using a PutImage function incorporated in the Profile, a Remote Display function incorporated in the Profile, and an Abort operation incorporated in Generic Object Exchange Profile, respectively.

13. A transmission method comprising:
transmitting one of data and a command;
inputting one of a first instruction to transmit the data and a second instruction to transmit the command;
starting a first transmission of the data when the first instruction is input;
starting a second transmission of the command when the second instruction is input and the data fails to be transmitted; and
interrupting the first transmission and starting the second transmission when the second instruction is input and the data is transmitted.

14. The transmission method according to claim 13, further comprising resuming the first transmission interrupted, the first transmission interrupted being restarted after the command has been transmitted.

15. The transmission method according to claim 13, further comprising sequentially transmitting a plurality of data items of the data.

16. The transmission method according to claim 13, wherein when the second instruction is input and the data is transmitted, determining whether or not the first transmission should be interrupted,
starting the second transmission after the first transmission is completed if it is determined that the first transmission should be uninterrupted,
interrupting the first transmission and starting the second transmission if it is determined that the first transmission should be interrupted.

17. A computer program product configured to store program instructions for execution on a computer system enabling the computer system to perform:
transmitting one of data and a command;
inputting one of a first instruction to transmit the data and a second instruction to transmit the command;
starting a first transmission of the data when the first instruction is input;
starting a second transmission of the command when the second instruction is input and the data fails to be transmitted; and
interrupting the first transmission and starting the second transmission when the second instruction is input and the data is transmitted.

18. The computer program product according to claim 17, further comprising resuming the first transmission interrupted, the first transmission interrupted being restarted after the command has been transmitted.

19. The computer program product according to claim 17, further comprising sequentially transmitting a plurality of data items of the data.

20. The computer program product according to claim 17, wherein when the second instruction is input and the data is transmitted, determining whether or not the first transmission should be interrupted,
starting the second transmission after the first transmission is completed if it is determined that the first transmission should be uninterrupted,
interrupting the first transmission and starting the second transmission if it is determined that the first transmission should be interrupted.
